(19) United States
(12) Patent Application Publication
(10) Pub. No.: US 2008/0048394 A1
(43) Pub. Date: Feb. 28, 2008

(54) Automatic Dice- Throwing Method and its Device

(76) Inventor: Lin C. H., Sanchong (TW)

Correspondence Address: Richard Chen, 7F., No. 122 Sung Chiang Rd., Taipei, omitted

(21) Appl. No.: 11/466,455

(22) Filed: Aug. 23, 2006

(51) Int. Cl. G07C 15/00

(52) U.S. Cl. 273/144 R; 273/144 A

(57) ABSTRACT

The invention is related to an automatic dice-throwing method and its device. The method is mainly to achieve dice throwing by an automatic device, which consists of; driving the dice container to rotate 180 degrees, driving the arm to capture the dice, driving the dice container to rotate and return and riving the arm to return and throw the dice; the device has a large driving motor to control the rotation and return of the dice container and uses a small driving motor to control the swinging and return of an arm; to facilitate the operation a controller is installed, to facilitate getting the result a small camera records the process and a display shows the points.

### BACKGROUND OF THE INVENTION

1. Field of the Invention

The invention is related to an automatic dice-throwing method and its device. Especially it refers to a remote controller to control the mechanical motion and automatically carry out dice throwing.

2. Description of the Prior Art

In many entertainments or games, dice throwing is commonly seen, not only in private, but also in business. Normally, one player throws the dice into a container, and then the game proceeds with the points counted.

Usually, dice throwing is carried out manually, and also raises concerns about its fairness because the throwing strength or angle could be controlled to generate expected results. Cheating could also happen to result in an unpleasant situation, such as dices that contain metals inside.

Besides, another unpleasant situation frequently seen in traditional dice throwing is throwing the dice out of the container because the player uses excessive force.

To improve the above shortcoming, the invention provides an automatic dice-throwing device with increased fairness and minimized cheating.

### SUMMARY OF THE INVENTION

The main objective for the invention is to provide an automatic dice-throwing method and device, which not only eliminates human factors in unfairness but also saves manpower as in traditional fashion. The device also shines during operation, adding aesthetic feel and visual entertaining effect.

To achieve the above objective, the invention allows dice throwing to be completed by automatic equipment, including rotating the container 180 degrees, arm capturing the dice, returning the container to the original position, and returning the arm to the original position and throwing the dice etc. The device has a large driving motor to control the motion of the container and a small driving motor to control the motion of the arm. To facilitate operation, there is a controller. To facilitate counting the points, there is a small camera above the container to send the screen to a display.

### BRIEF DESCRIPTION OF THE DRAWINGS

FIG. 1 is the structural disassembly for the automatic dice-throwing device in the invention.

FIG. 2 is the exterior appearance for the automatic dice-throwing device in the invention.

FIG. 3 is the planar structure diagram for the automatic dice-throwing device in the invention.

FIG. 4 is an illustration for the dice-throwing action by the automatic dice-throwing device in the invention (1).

FIG. 5 is an illustration for the dice-throwing action by the automatic dice-throwing device in the invention (2).

### DETAILED DESCRIPTION OF THE PREFERRED EMBODIMENT

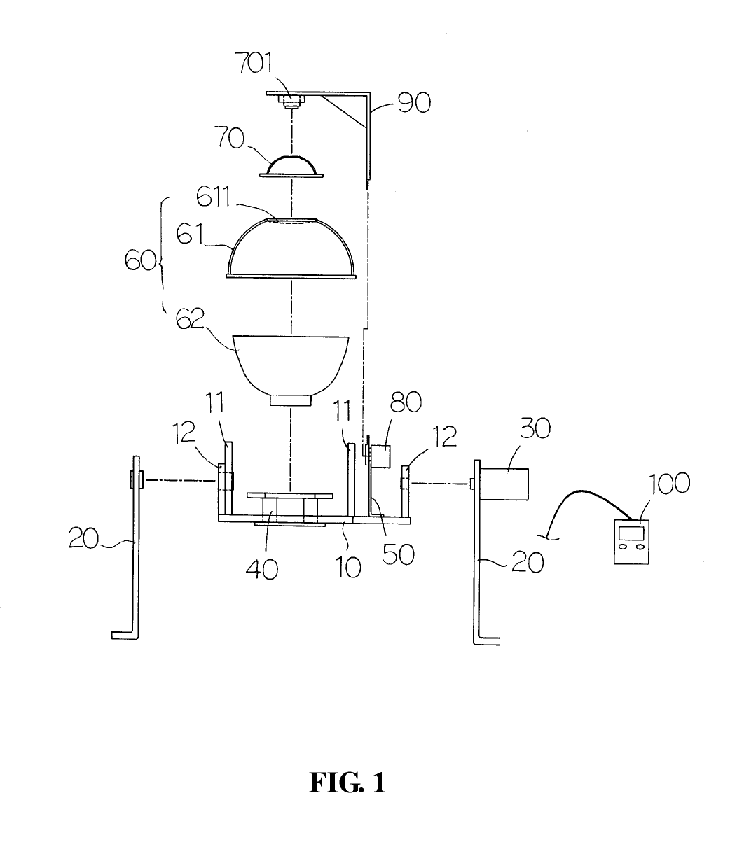

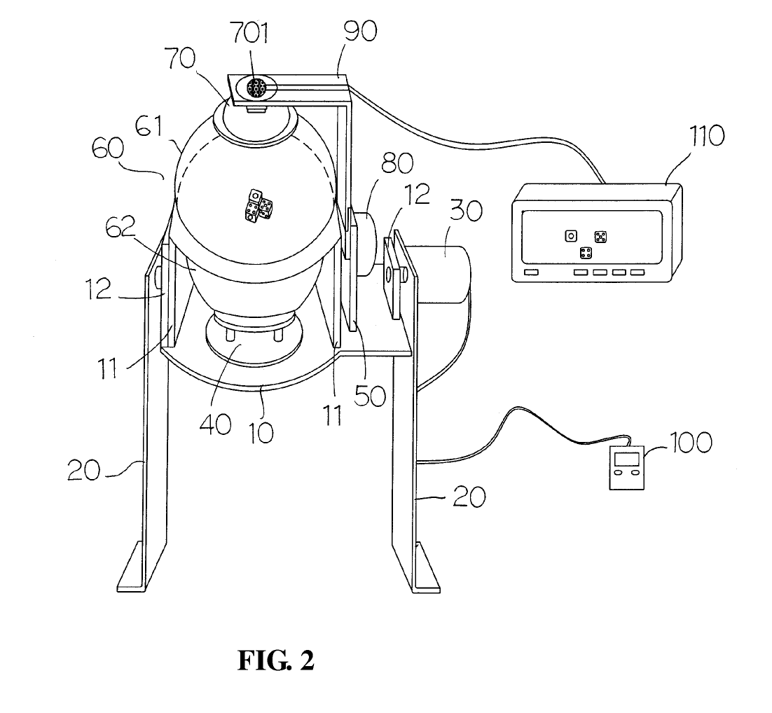

Please refer to FIG. 1 and FIG. 2 for the entire structure for the automatic dice-throwing device in the invention. The device consists of the following:

The base (10) for the container (60) has a transparent clamp (40) and a bowl container (62) adhered with caulking. Inside the clamp (40) there is an illuminator that shines and provides visual effect. On the two sides of the clamp (40) there are vertical plates (11) of equal height that fasten to the edge of the top cover (61), so they allow sealing and coverage of the bowl-shape container (62). The top cover (61) is transparent and has a hole (611) on its top. On the base (10) there is a small vertical board (50) between the vertical plate (11) and a support plate (12). A small driving motor (80) connects to a reverse L-shaped arm (90). At the end of the arm (90) there is a small camera (71) with an attached small container (70). The small driving motor (80) drives the arm (90) to swing, so the small container (70) can completely cover or uncover the hole (611) on the top cover (61). The small camera (71) can record the entire dice throwing process and the points of the dice in the container (62) at the end.

A pair of vertical boards (20) that connect to the side of the base (10) are located on the outer side of the two support plates (12). One has a large driving motor (30) on it to drive the entire base (10) for 180-degree rotation and return to provide dice rolling function.

There are a controller (100) and a display (110) that both have internal control circuit. The controller (100) electrically connects to the large and small driving motors (30, 80) to enable remote control for the automatic dice throwing. The connection of the display (110) and the small camera (71) enables the recorded dice throwing process by the small camera (71) to be shown on the display (110).

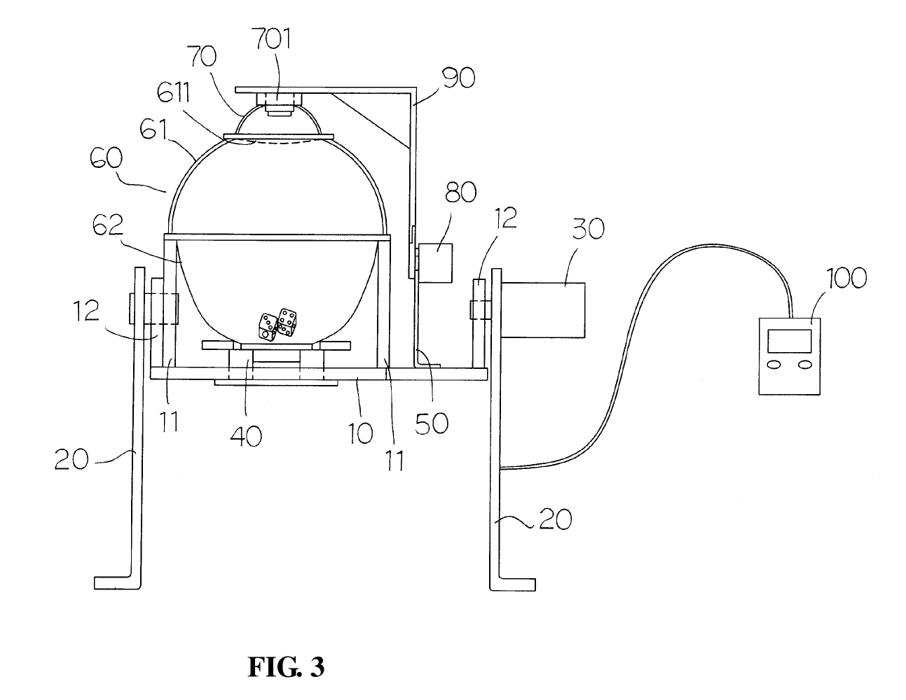

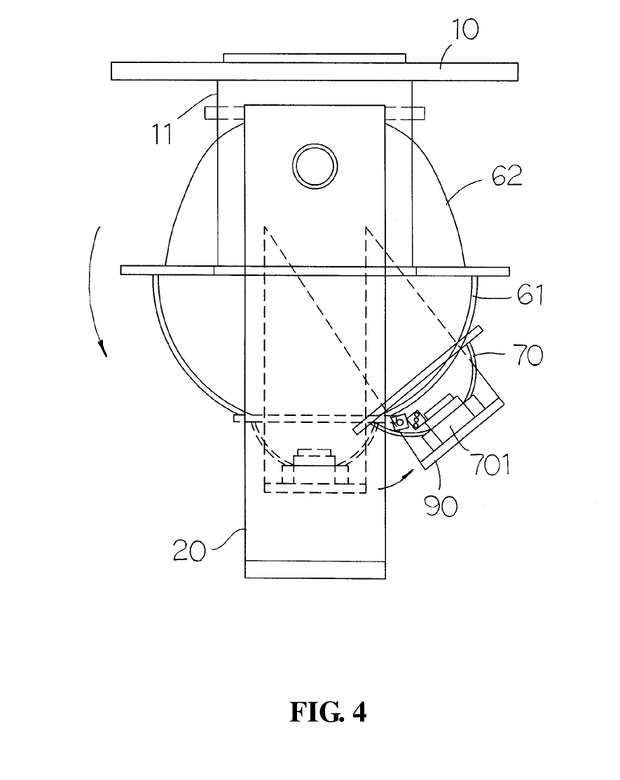

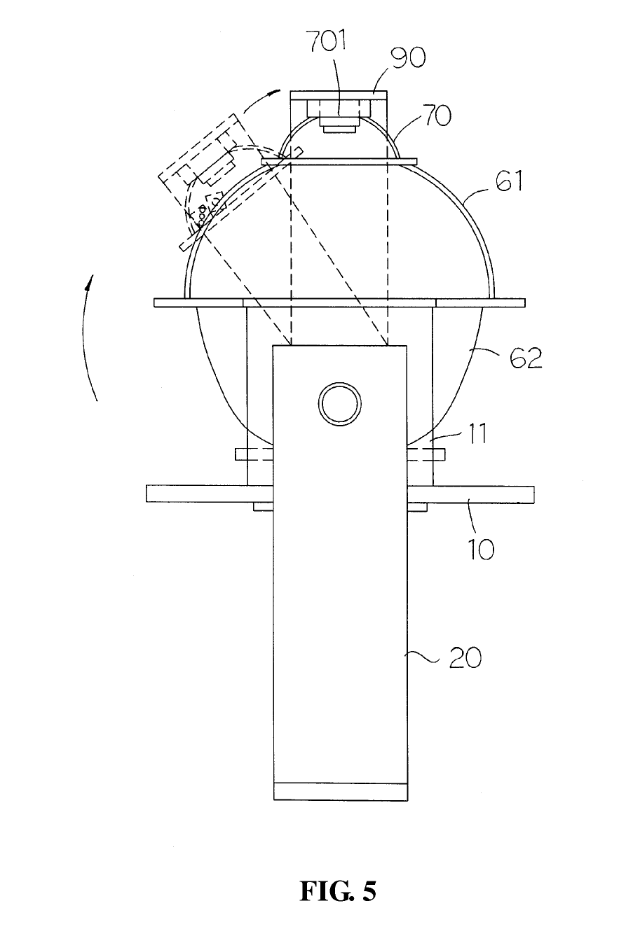

Please continue to refer to FIG. 3 for the initial state when the dice stays in the bottom of the bowl container (62) of the dice container (60). As soon as the user sends a re-throwing command through the controller (100), the large driving motor (30) starts driving the entire base (10) to rotate downward 180 degrees, as shown in FIG. 4. Because of the hole (611) that allows pass of the dice, the dice on the bottom of the bowl container (62) will fall into the small container (70). Immediately, the small driving motor (80) starts running to drive the arm (90) swinging, so the small container (70) moves along the surface of the top cover (61) until is completely away from the hole (611). The large driving motor (30) will start to bring the base (10) back to the original position in reversed rotation, as shown in FIG. 5. Then, the small driving motor (80) will return the arm (90) back to the original position. This allows the small container (70) to cover the hole (611) again. At this moment, the dice drops into the bowl container (62). This completes a dice-throwing cycle. Thus, the user can directly see the dice inside the bowl container (602) or view the dice on the display (110), and is able to count the points.

On the other hand, the illuminator inside the clamp (40) will flash as the large and the small driving motors (30, 80) are driving the base (10) and the arm (90) in rotation. Thus, it creates a vivid visual effect that is also entertaining.

In summary, the invention for an automatic dice-throwing method and its device not only saves manpower as in traditional dice-throwing fashion but also improves on fairness in the dice-throwing process. Therefore, the invention meets the qualifications to apply for a patent. The above-mentioned embodiment is just one preferred embodiment, any change and modification to lead to equivalent effect within the claims are also considered to be covered in the claims.

What is claimed is:

1. An automatic dice-throwing method consists of the following steps:
rotate the dice holding container 180 degrees;
swing the arm to capture the dice;
return the dice container to the original position;
return the arm to the original position and throw the dice;
show the points of the dice.

2. As described in claim 1 for an automatic dice-throwing method, the equipment to drive the rotation of the container is a large driving motor.

3. As described in claim 1 for an automatic dice-throwing method, the equipment to drive the swinging of the arm and return it to the original position is a small driving motor.

4. As described in claim 1 for an automatic dice-throwing method, the result of the dice points is recorded by a camera and shown by a display.

5. An automatic dice-throwing method consists of:
a dice holding container and its base, a clamp, two vertical plates of equal height on the two sides of the clamp and extending to the edge of the top cover, a top cover hole; a small vertical board between a vertical plate and a support plate on the base, a small driving motor connecting to a reversed L-shape arm, a small camera with a small container at the end of the arm, so the small driving motor drives the swinging of the arm and the small container either completely covers or uncovers the top cover hole;
a pair of vertical boards on the side of the base, and on the outer sides of the two support plates, one with a large driving motor to drive the base for 180-degree rotation and return; and
a controller and a display, both with internal control circuit, and the controller electrically connects to the large and the small driving motors to remote control the dice throwing; the display connects to the small camera and shows the dice throwing process recorded by the small camera.

6. As described in claim 5 for an automatic dice-throwing device, the clamp is transparent and contains an illuminator.

7. As described in claim 5 for an automatic dice-throwing device, the large driving motor is attached at any position to control the rotation of the dice container.

8. As described in claim 5 for an automatic dice-throwing device, the bowl container is attached to the clamp by caulking.

9. As described in claim 5 for an automatic dice-throwing device, the top cover is made of transparent material.
